(19) United States
(12) Patent Application Publication
(10) Pub. No.: US 2022/0027991 A1
(43) Pub. Date: Jan. 27, 2022

(54) SYSTEMS AND METHODS FOR TRACKING AND REPORTING USER INTERACTIONS WITH DATA OBJECTS

(71) Applicant: Click IPO Holdings, LLC, Scottsdale, AZ (US)

(72) Inventors: Sukanta Ganguly, San Jose, CA (US); Scott Coyle, Scottsdale, AZ (US)

(21) Appl. No.: 17/384,032

(22) Filed: Jul. 23, 2021

Related U.S. Application Data
(60) Provisional application No. 63/056,205, filed on Jul. 24, 2020.

(51) Int. Cl. G06Q 40/04

(52) U.S. Cl. CPC G06Q 40/04

(57) ABSTRACT

An event analysis (EA) computing device is described. The EA computing device includes at least one processor in communication with a database and a plurality of user computing devices. The at least one processor is configured to receive a user interaction data signal, store a first data extracted from the user interaction data signal in a first database, (i) transmit a notification data signal to one of the user computing devices, and (ii) generate and store a user trail record in a second database as a linked element in a user trail. The processor is also configured to retrieve the first data from the first database and use the first data to implement a primary functionality of the EA computing device, retrieve the user trail and use the user trail to generate a report, and transmit the report to one of the user computing devices.

### CROSS REFERENCE TO RELATED APPLICATIONS

This application claims the benefit of priority to U.S. Provisional Patent Application No. 63/056,205, filed Jul. 24, 2020, the contents and disclosure of which are hereby incorporated by reference in their entireties.

### BACKGROUND

The field of the disclosure relates generally to tracking and reporting multiple aspects of user interactions with data objects and, more specifically, to a computer system configured to generate data maps to enable automated tracking and reporting of interactions between multiple users and data objects associated with multiple endeavors.

Many endeavors are subject to compliance reporting requirements, established for example by governmental regulations, trade associations, or customer demand. One such endeavor is a public asset offering such as an initial public offering (IPO), in which an issuer sells shares of a corporation to investors, such as individual investors and institutional investors (e.g., banks, insurance companies, hedge funds, and mutual funds). Individual investors often purchase shares through a broker, also known as a broker-dealer, who handles buy and sell orders for assets on behalf of clients who may participate in any number of public asset offerings. It is often necessary for brokers to maintain highly-detailed records regarding involvement of their investor-clients in each of several offerings, for example to facilitate regulatory compliance, reporting to investors, and/or audit response reports.

Currently, creating complete and fully compliant reports requires a manual and labor-intensive process of compiling event information relating to a plurality of separate endeavors, and to a plurality of interactions with a plurality of individuals each related to one or more of the endeavors. For example, it is difficult to manually track relationships of parties involved in any particular endeavor, and associate those relationships with different events that occur throughout the development and completion of the endeavor. Maintaining a detailed record of these events and relationships, and being able to compile and report them in a prescribed manner to satisfy regulatory requirements and/or respond to audits, is a primary source of labor and expense for many endeavors, and an impact of failing to do so in the prescribed manner is a primary risk faced in such endeavors. Accordingly, systems and methods are desired for automatically tracking events and interactions that occur throughout the initiation and completion of such endeavors.

### BRIEF DESCRIPTION

In one aspect, an event analysis (EA) computing device is described. The EA computing device includes at least one processor in communication with a database and a plurality of user computing devices corresponding to a plurality of users. The at least one processor is configured to receive a user interaction data signal from a first of the user computing devices, store a first data extracted from the user interaction data signal in a first database, and in response to the user interaction signal, (i) transmit a notification data signal to one of the first user computing device and a second of the user computing devices, and (ii) generate and store a user trail record in a second database as a linked element in a user trail, wherein the user trail is associated with a user of one of the first user computing device and the second user computing device. The processor is also configured to retrieve the first data from the first database and use the first data to implement a primary functionality of the EA computing device, retrieve the user trail from the second database and use the user trail to generate a report, and transmit the report to one of the user computing devices.

In another aspect, a computer-implemented method is described. The method is implemented by an event analysis (EA) computing device including at least one processor in communication with a database. The method includes receiving a user interaction data signal from a first of the user computing devices, storing a first data extracted from the user interaction data signal in a first database, and in response to the user interaction signal, (i) transmitting a notification data signal to one of the first user computing device and a second of the user computing devices, and (ii) generating and storing a user trail record in a second database as a linked element in a user trail, wherein the user trail is associated with a user of one of the first user computing device and the second user computing device. The method also includes retrieving the first data from the first database and using the first data to implement a primary functionality of the EA computing device, retrieving the user trail from the second database and using the user trail to generate a report, and transmitting the report to one of the user computing devices.

In another aspect, a non-transitory computer-readable storage medium having computer-executable instructions embodied thereon is described. When executed by at least one event analysis (EA) computing device, including at least one processor in communication with at least one database, the computer-executable instructions cause the EA computing device to receive a user interaction data signal from a first of the user computing devices, store a first data extracted from the user interaction data signal in a first database, and in response to the user interaction signal, (i) transmit a notification data signal to one of the first user computing device and a second of the user computing devices, and (ii) generate and store a user trail record in a second database as a linked element in a user trail, wherein the user trail is associated with a user of one of the first user computing device and the second user computing device. The instructions further cause the EA computing device to retrieve the first data from the first database and use the first data to implement a primary functionality of the EA computing device, retrieve the user trail from the second database and use the user trail to generate a report, and transmit the report to one of the user computing devices.

### BRIEF DESCRIPTION OF THE DRAWINGS

FIG. 1 is a schematic diagram of an example public asset offering environment illustrating an example event analysis (EA) computing device in communication with participant computing devices, broker-dealer computing devices, and an issuer computing device

FIGS. 2A, 2B, and 2C are schematic data flow diagrams illustrating example communications among the EA computing device, the participant computing devices, the broker-dealer computing devices, and the issuer computing device shown in FIG. 1.

FIGS. 2D, 2E, and 2F are schematic block diagrams illustrating example data map generation by the EA computing device shown in FIG. 1 in response to the communications shown in FIGS. 2A-2C.

FIG. 3 is an example configuration of a user system that may be used to implement the participant computing devices, broker-dealer computing devices, and/or the issuer computing device shown in FIG. 1.

FIG. 4 is an example configuration of a server system that may be used to implement the EA computing device shown in FIG. 1.

FIG. 5 is a flow diagram illustrating an example process by which events may be analyzed using the EA computing device shown in FIG. 1.

FIG. 6 is a diagram of programmatic computer components that may be executed by the EA computing device shown in FIG. 1.

### DETAILED DESCRIPTION

The following detailed description illustrates embodiments of the disclosure by way of example and not by way of limitation. The description enables one skilled in the art to make and use the disclosure, and describes several embodiments, adaptations, variations, alternatives, and uses of the disclosure, including what is presently believed to be the best mode of carrying out the disclosure. The disclosure is described as applied to an example embodiment, namely, systems and methods for tracking and reporting user interactions with data objects related to asset offerings, such as but not limited to offers to purchase shares of a company in an initial public offering (IPO). The system described herein includes at least one event analysis (EA) computing device that automatically tracks user interactions with data objects. In the example embodiment, the EA computing device is configured to be in communication with at least one broker-dealer computing device, a large number of participant computing devices, at least one issuer computing device, and at least one database.

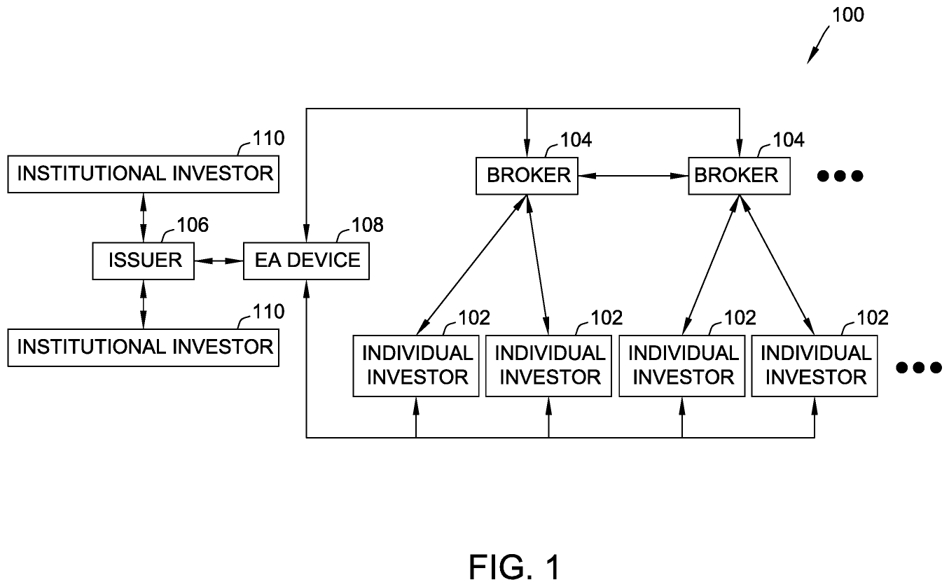

As used herein, “user,” “participant,” and/or “investor” may refer to an individual, or group of individuals, operating a device shown in the environment displayed in FIG. 1.

As used herein, “dynamic data map” and/or “data map” may refer to data stored in a database that includes links to other data. For example, as activity is tracked and analyzed by the EA computing device as described herein, all data generated by the EA computing device and stored in a database is linked to other data. In other words, each data entry in a data map generated by the EA computing device includes information to link that data entry to at least one other data entry. Accordingly, data maps are automatically created by data entries that are linked to each other (e.g., forming a data trail/user trail). Separate data maps may be created for each participant in a common activity, for example to track involvement in a public offering of assets separately for each investor and for each broker-dealer. In some embodiments, an overall data map is also created for each interaction with the public offering itself. In some embodiments, a data map may be in the form of a context-based directed acyclic (C-DAG) graph.

In the example embodiment, the EA computing device is configured to track activity occurring during a financial event, such as an IPO wherein an issuer sells, for example, shares of stock in a corporation in exchange for funds. For example, the EA computing device is configured to facilitate communication between parties involved in an IPO, such as an issuer, at least one broker-dealer, and at least one participant. In particular, the EA computing device may be configured to automatically select individual (that is, an individual human rather than a business entity) investors that are good candidates to participate in an offering, based on their past investment behavior; present details of the offering to the selected individual investors, either directly or through the investors' broker-dealers; receive conditional offers to buy (COBs) from one or more of the selected individual investors; present aggregated offers from the individual investors, for example, in an amount comparable to offers from institutional investors; and automatically allocate assets to the individual investors, as described in commonly owned U.S. patent application Ser. No. 16/253,657, which is hereby incorporated by reference in its entirety. Activities such as these are subject to complex customer reporting, compliance reporting, and audit response duties. In the example embodiment, the EA computing device automatically maps all activity of each involved party and generates data entries for storage in a database. The data entries are each configured to be stored in at least one data map as described above. As described below, the data structures used to implement the at least one data map enable the EA computing device to automatically generate, for example, audit response reports and/or information and compliance tracking and reporting for a broker-dealer, with greatly increased speed and accuracy as compared to conventional tracking and reporting systems, without the use of a separate tracking system and without any need to re-analyze or re-compile electronic or paper communications associated with each interaction with an investor.

The technical problems addressed by the disclosure include at least one of: (i) a need to crawl or parse electronic and paper communication records to generate audit response reports and/or information and compliance reports; (ii) a need to maintain both a first computing system to enable and implement user interactions with an event, and a separate second computing system for generating audit response reports and information and compliance reports based on the user interactions; and (iii) inability of a single computing system to efficiently track all interactions of a large number of users with one or more endeavors, such as individual investors participating in one or more asset offerings from one or more issuers via one or more intermediary broker-dealers.

The technical effects achieved by the systems and methods described herein include at least one of: (i) receiving a user interaction data signal from a first of the user computing devices; (ii) storing a first data extracted from the user interaction data signal in a first database; (iii) in response to the user interaction signal, transmitting a notification data signal to one of the first user computing device and a second of the user computing devices, and generating and storing a user trail record in a second database as a linked element in a user trail, wherein the user trail is associated with a user of one of the first user computing device and the second user computing device; (iv) retrieving the first data from the first database and use the first data to implement a primary functionality of the EA computing device; (v) retrieving the user trail from the second database and use the user trail to generate a report; and (vi) transmitting the report to one of the user computing devices

The resulting technical benefits achieved by the systems and methods of the disclosure include at least one of: (i) automatic generation of complete audit response reports and/or information and compliance reports directly from stored data maps, wherein each element of the data map is created contemporaneously with the corresponding action to be reported; (ii) implementing, in a common computing system, user interactions with an event, such as handling individual investor interactions with a public offering of assets through multiple broker-dealers, and also generation of audit response reports and information and compliance reports based on the user interactions; (iii) efficient tracking of all interactions of a large number of users with one or more endeavors, such as individual investors participating in one or more asset offerings from one or more issuers via one or more intermediary broker-dealers.

In one embodiment, a computer program is provided, and the program is embodied on a computer readable medium. In an example embodiment, the system is executed on a single computer system, without requiring a connection to a server computer. In a further example embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Cisco Systems, Inc. located in San Jose, Calif.). In yet a further embodiment, the system is run on a Mac OS® environment (Mac OS is a registered trademark of Apple Inc. located in Cupertino, Calif.). The application is flexible and designed to run in various different environments without compromising any major functionality. In some embodiments, the system includes multiple components distributed among a plurality of computing devices. One or more components are in the form of computer-executable instructions embodied in a computer-readable medium. The systems and processes are not limited to the specific embodiments described herein. In addition, components of each system and each process can be practiced independently and separately from other components and processes described herein. Each component and process can also be used in combination with other assembly packages and processes.

In one embodiment, a computer program is provided, and the program is embodied on a computer readable medium and utilizes a Structured Query Language (SQL) with a client user interface front-end for administration and a web interface for standard user input and reports. In another embodiment, the system is web enabled and is run on a business-entity intranet. In yet another embodiment, the system is fully accessed by individuals having an authorized access outside the firewall of the business-entity through the Internet. In a further embodiment, the system is being run in a Windows® environment (Windows is a registered trademark of Microsoft Corporation, Redmond, Wash.). The application is flexible and designed to run in various different environments without compromising any major functionality.

As used herein, an element or step recited in the singular and preceded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

As used herein, the term “database” may refer to either a body of data, a relational database management system (RDBMS), or to both. A database may include any collection of data including hierarchical databases, relational databases, flat file databases, object-relational databases, cloud databases, object oriented databases, and any other structured collection of records or data that is stored in a computer system. The above examples are for example only, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.).

The term processor, as used herein, may refer to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are for example only, and are thus not limiting as to the types of memory usable for storage of a computer program.

FIG. 1 is a schematic diagram of an example environment 100 of endeavor including multiple participants, in which complex regulatory, audit response reports, and/or informational reporting requirements apply. More specifically, environment 100 is illustrated as a public offering of assets, for example an IPO. Environment 100 includes an example event analysis (EA) computing device 108 in communication with individual investor/investor computing devices 102, broker-dealer computing devices 104, and an issuer computing device 106. Issuer computing device 106 is in communication with at least one institutional investor computing device 110.

Each broker-dealer computing device 104 is associated with a corresponding broker-dealer in environment 100. A broker-dealer is an individual or organization that engages in the business of trading securities (e.g., stock) on behalf of the broker-dealer's customers (e.g., individual investors associated with investor computing devices 102). Broker-dealer computing device 104 may store and/or generate historical investor data corresponding to investment activity of individual investors through the broker-dealer corresponding to broker-dealer computing device 104. Each broker-dealer computing device 104 is in direct communication with EA computing device 108 and with investor computing devices 102 of each customer of the broker-dealer.

Issuer computing device 106 is associated with an issuer of a public offering such as an IPO. The issuer sells, for example, shares of stock in a corporation in exchange for funds. The issuer may be in communication with any number of institutional investors 110 outside the channels provided by EA computing device 108.

In the example embodiment, EA computing device 108 is configured to implement a primary functionality associated with the endeavor, through user interactions of various parties with the endeavor. For example, EA computing device 108 is configured to automatically select individual investors 102 that are good candidates to participate in a particular offering from issuer 106, based on the past investment behavior of the respective individual investor 102. For example, the past investment behavior is evaluated to determine a likelihood that the individual investor 102 will handle any resulting purchase of the offering in a manner beneficial to the issuer 106. EA computing device 108 presents details of the offering to the selected individual investor computing devices 102, either directly or through broker-dealer computing devices 104. EA computing device 108 then receives conditional offers to buy (COBs) from one or more of the selected individual investor computing devices 102, again either directly or through broker-dealer computing devices 104, and presents aggregated offers from the individual investors 102 to issuer computing device 106. For example, an amount of the aggregated offers is comparable to offers from institutional investors 110, thus placing individual investors 102 and broker-dealers 104 in a stronger position to obtain participation in the offering. After issuer computing device 106 communicates a total amount of the offering that will be made available to the individual investors 102, EA computing device 108 automatically allocates the assets to the individual investors 102, again according to expected investment behavior of the individual investors 102. Although only one issuer 106 is shown, EA computing device 108 may simultaneously or sequentially handle multiple offerings from multiple issuers 106, and one or more individual investors 102 may be selected for participation in multiple offerings via one or more broker-dealers 104. In alternative embodiments, EA computing device 108 implements any suitable primary functionality and/or environment 100 represents any suitable endeavor for which the data mapping and compliance/audit response/informational reporting techniques described herein are suited.

In the example embodiment, in addition to the primary functionality, EA computing device 108 is also configured to implement data mapping and compliance/audit response/informational reporting for activity occurring in environment 100. In the example of FIG. 1, EA computing device 108 is configured to implement data mapping and compliance/audit response/informational reporting specifically for activity by broker-dealers 104 and individual investors 102 in connection with a public offering of assets by issuer 106. Accordingly, EA computing device 108 is in direct communication with each broker-dealer computing device 104 and in direct or indirect communication with investor computing devices 102. In some embodiments, EA computing device 108 also implements data mapping and compliance/audit response/informational reporting for activity occurring by at least one issuer associated with issuer computing device 106, and/or institutional investor activity via institutional investor computing device 110.

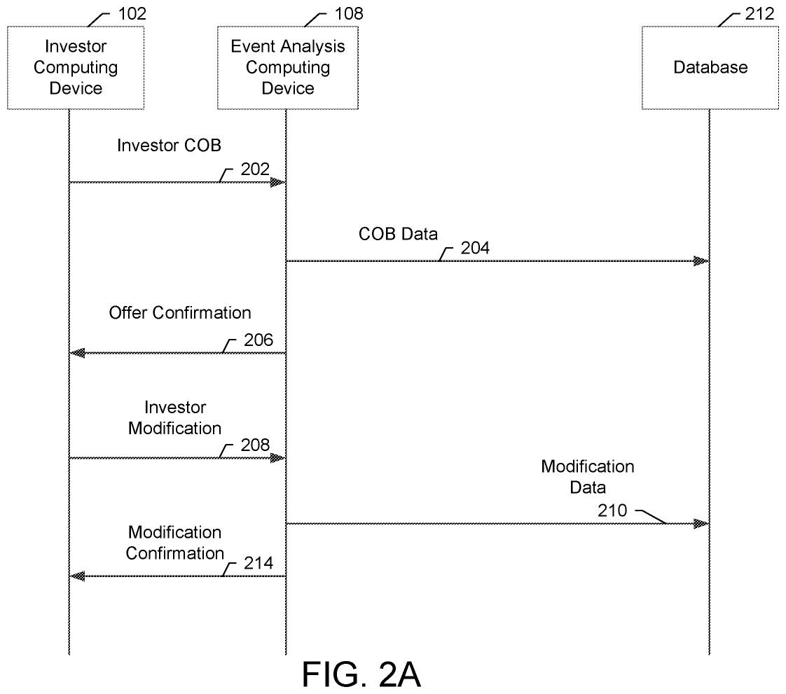

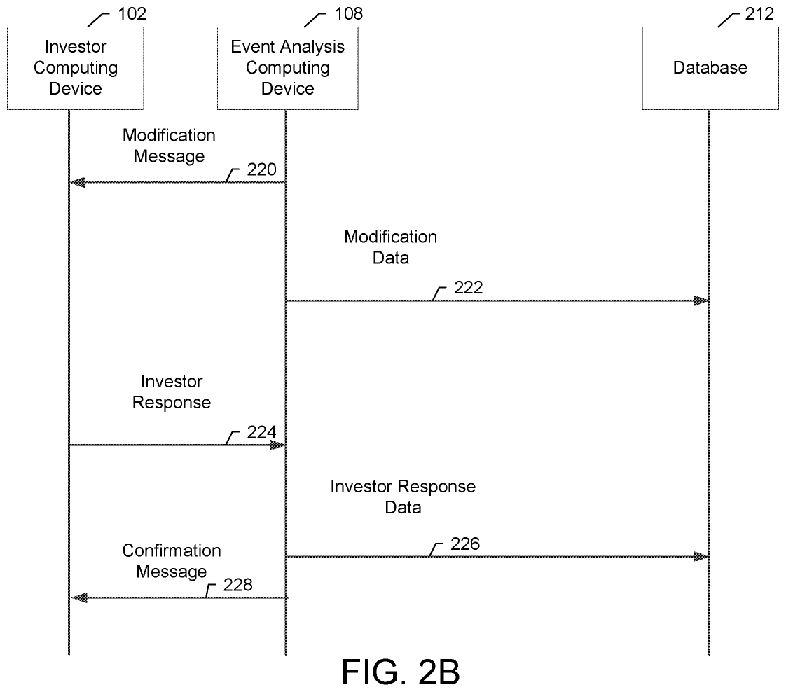

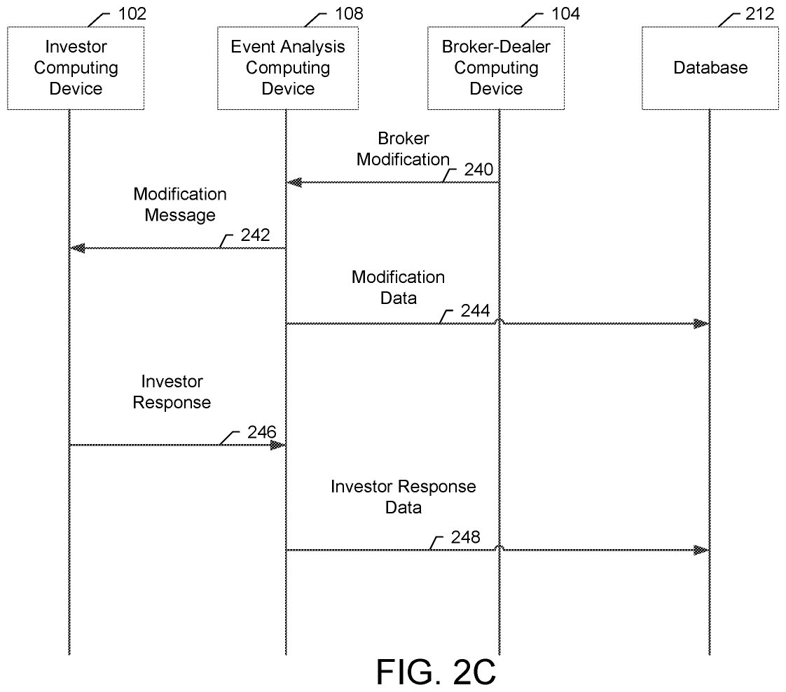

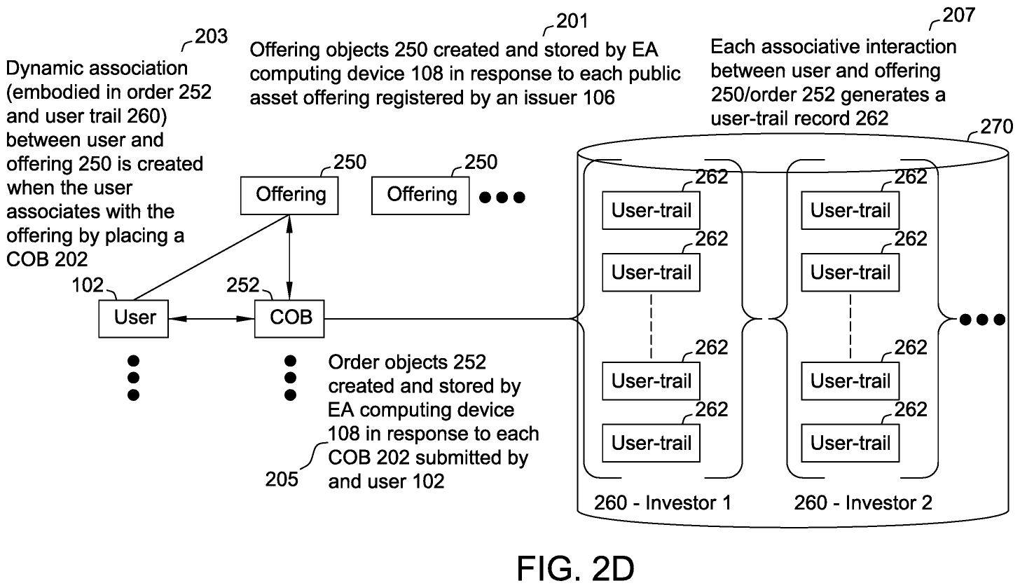

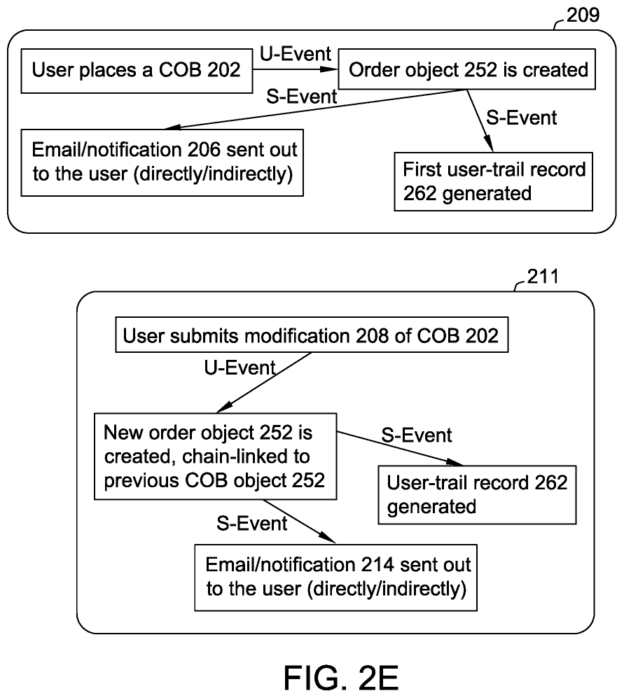

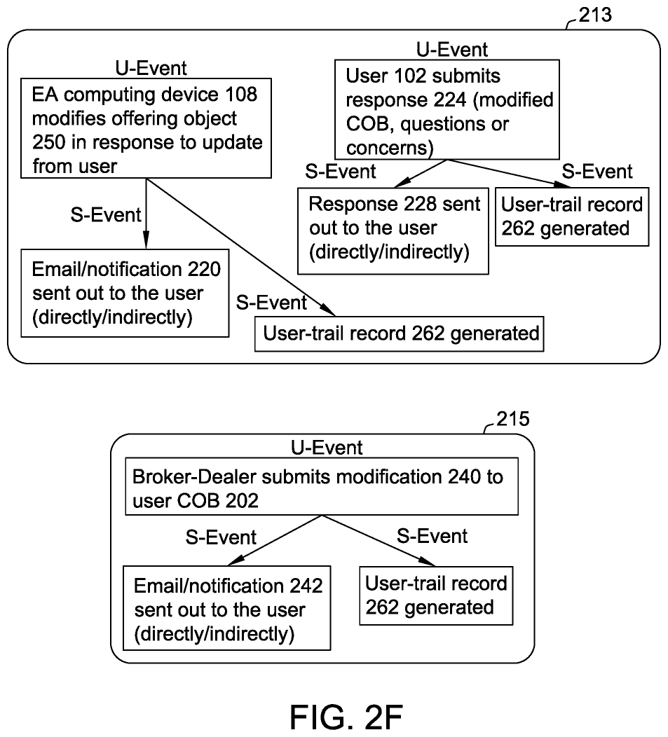

By analyzing and tracking activity from broker-dealer computing devices 104 and investor computing devices 102 and creating elements of a data map contemporaneously with each interaction that may need to be reported, EA computing device 108 is enabled to generate detailed and complex reports required for auditing and reporting purposes, and specifically tailored to each broker-dealer associated with a broker-dealer computing device 104 and/or each individual investor associated with an investor computing device 102, while reducing or eliminating any need to review and analyze past communications between broker-dealer computing devices 104 and investor computing devices 102 at the time of the report. FIGS. 2A-2F illustrate examples of interactions that may be added to the data map by EA computing device 108. Although some examples described herein illustrate transmission of messages from investor computing device 102 to EA computing device 108, it should be appreciated that some or all such messages may be routed through broker-dealer computing device 104, for example via a communication channel provided by a broker-dealer application or broker-dealer website familiar to the individual investor 102.

FIGS. 2A-2C are schematic data flow diagrams illustrating example communications among EA computing device 108, the participating investor computing devices 102, broker-dealer computing devices 104, and issuer computing device 106 for a particular offering of assets. FIGS. 2D-2F are schematic block diagrams illustrating example data map generation by EA computing device 108 in response to the communications shown in FIGS. 2A-2C. With reference to FIGS. 2A-2F, at the time of an IPO as described above, investors may be given the opportunity to invest in a company. In particular, individual investors 102, who in conventional situations may have limited opportunity to compete against institutional investors 110 for shares, may be given the opportunity to participate in the offering via selection by EA computing device 108 based on data provided by broker-dealer computing devices 104 and/or past investment activity of the individual investor 102 conducted through EA computing device 108, as more fully described in commonly owned U.S. patent application Ser. No. 16/253,657.

In response to each public asset offering registered (e.g., via a registration signal) by an issuer 106 with EA computing device 108, a corresponding “offering” data object 250 is created and stored by EA computing device 108. This is indicated as event 201 in FIG. 2D. Offering object 250 may have properties recording salient aspects of the particular offering. In some embodiments, each interaction with offering object 250 causes the creation of an issuer trail record in a comprehensive offer data map (not shown). After selection for participation in the offering by EA computing device 108, one of investor computing devices 102 may transmit a data signal to EA computing device 108, indicating conditional offers to buy (“COB”) a stated amount of shares the individual is willing to buy. EA computing device 108 extracts or generates COB data 204 from COB 202. For example, COB data 204 includes data indicating an investor associated with investor computing device 102 (e.g., the investor who submitted the offer), a broker-dealer associated with broker-dealer computing device 104, a date and time that COB 202 was submitted, and other information pertaining to COB 202. COB data 204 may be stored in a database 212 and used for a primary functionality of EA computing device 108. In the example embodiment, COB data 204 is later used by EA computing device 108 executing the primary functionality to compile an aggregate offer to issuer 106 and, if issuer 106 makes all or part of the requested assets available in response, to determine an allocation of assets to the individual investor 102. In response to receiving COB 202, EA computing device 108 may be configured to transmit a notification/confirmation data signal 206 to investor computing device 102 confirming receipt of COB 202.

In addition, in response to the individual investor associating with the offering by transmitting COB 202, EA computing device 108 creates a dynamic association 203 between that individual investor 102 and the offering represented by offering object 250. In the example embodiment, dynamic association 203 is embodied in an order object 252 and a user trail 260. More specifically, in response to each COB 202 transmitted by one of investor computing devices 102, a corresponding “order” data object 252 is created by EA computing device 108. This is indicated as event 205 in FIG. 2D. In the example embodiment, the order object 252 inherits the attributes of the offering object 250. At least some additional properties of order object 252 may be represented by COB data 204 stored in database 212, or alternatively order object 252 may be maintained completely separate from COB 204. In addition, the creation of order object 252 causes EA computing device 108 to initiate and store user trail 260, for example in a database 270. User trail 260 is a data map specific to the individual investor 102 and the particular offering of assets. For example, EA computing device 108 creates and stores a first user-trail record 262 in response to the receipt of COB 202 and/or the creation of order object 252. First user-trail record 262 includes aspects of COB 202 that are, or may become, relevant to any compliance/informational report or audit response report. Once user trail 260 is initiated, each interaction associated with that individual investor 102 and offering object 250 or order object 252 generates a user-trail record 262 in database 270 linked directly to the previous user-trail record 262 in that user trail 260, as discussed above. This is indicated generally as event 207 in FIG. 2D.

Moreover, in the example embodiment, EA computing device 108 is programmed to generate the first user-trail record 262 and the confirmation signal 206 communicated to the investor computing devices 102 in a single event window 209, as illustrated in FIG. 2E. In other words, a single user interaction or “U-event,” in the form of COB 202, causes two parallel system events or “S-events,” the actual communication (confirmation signal 206) to the investor and the linked data-map element.

After initially submitting COB 202, in some cases individual investor 102 decides to submit a modification to COB 202. For example, investor computing device 102 transmits modification data signal 208 (shown in FIG. 2A) to EA computing device 108, indicating, for example, a modified stated amount of shares the individual is willing to buy. EA computing device 108 extracts or generates modification data 210, which may be stored in database 212 and used to implement the primary functionality of EA computing device 108. In the example embodiment, modification data 210 is subsequently used along with, or in place of, COB data 204 for compiling an aggregate offer to issuer 106 and allocating any resulting assets made available by issuer 106. In addition, a corresponding new “order” data object 252 that reflects modified data 210 is created by EA computing device 108, and includes data linking it directly to the original order object 252 for that individual investor 102. As discussed above, at least some properties of the new order object 252 may be represented by modification data 210 stored in database 212, or alternatively order object 252 may be maintained completely separate from modification data 210.

Because modification data signal 208 is another interaction of individual investor 102 with the offering, another event window 211 (shown in FIG. 2E) is triggered. In other words, a single user interaction, in the form of modification 208, causes two parallel system events, a modification notification data signal 214 (shown in FIG. 2A) transmitted to investor computing device 102 and another user-trail record 262 added to the data map embodied by user trail 260 in database 270. In a case in which modification 208 is the first interaction of individual investor 102 with the offering after COB 202, the resulting user-trail record 262 includes data directly linking the resulting user-trail record to the first user-trail record 262, as discussed above. Alternatively, the resulting user-trail record 262 is linked to another most recent user-trail record 262 in the user trail 260 for the corresponding individual investor 102.

User trail 260 also reflects events triggered by other users that affect the individual investor 102. For example, issuer 106 may modify details of the offering of public assets, triggering event window 213 (shown in FIG. 2F). EA computing device 108 extracts or generates modification data 222, which may be stored in database 212 and subsequently used to implement the primary functionality of EA computing device 108. In the example embodiment, modification data 222 is used by EA computing device 108 for selecting additional or different individual investors 102 as candidates to participate in the offering, compiling an aggregate offer to issuer 106, and allocating any resulting assets made available by issuer 106. Moreover, EA computing device 108 modifies offering object 250 associated with the offering. At least some properties of the modified offering object 250 may be represented by modification data 222 stored in database 212, or alternatively offering object 250 may be maintained completely separate from modification data 222.

In addition, the user interaction by the issuer 106 causes two parallel system events, a modification notification data signal 220 (shown in FIG. 2B) transmitted to investor computing device 102 and another user-trail record 262 added to the data map embodied by user trail 260 in database 270. The resulting user-trail record 262 is linked to the most recent user-trail record 262 in the user trail 260 for the corresponding individual investor 102. In some cases, individual investor computing device 102 transmits a response data signal 224 to EA computing device 108, for example including questions, concerns, or a modification to COB 202. EA computing device 108 extracts or generates investor response data 226 for storage in database 212, similar to as described above, for potential use in implementing the primary functionality of EA computing device 108. Because response 224 is also a user interaction, it triggers two more parallel system events, a response or receipt confirmation notification data signal 228 (shown in FIG. 2B) transmitted to investor computing device 102 and another user-trail record 262 added to the data map embodied by user trail 260.

For another example, broker-dealer 104 may send a data signal 240 to EA computing device 108 that indicates a modification of details of COB 202 from the individual investor 102, triggering event window 215 (shown in FIG. 2F). EA computing device 108 extracts or generates modification data 244, which may be stored in database 212 and subsequently used for the primary functionality of EA computing device 108, e.g., compiling an aggregate offer to issuer 106 and allocating any resulting assets made available by issuer 106. The user interaction by broker-dealer 104 causes two parallel system events, a modification notification data signal 242 (shown in FIG. 2C) transmitted to investor computing device 102 and another user-trail record 262 added to the data map embodied by user trail 260. The resulting user-trail record 262 is linked to the most recent user-trail record 262 in the user trail 260 for the corresponding individual investor 102. In some cases, individual investor computing device 102 transmits a response data signal 246 to EA computing device 108, for example including questions, concerns, or a further modification to COB 202. EA computing device 108 extracts or generates investor response data 248 for storage in database 212, similar to as described above. The response is again a user event, and triggers system events similar to those described for event window 213.

It should be understood that any number of follow-up exchanges between EA computing device 108 and individual investor 102 are similarly automatically stored and linked in user trail 260. Moreover, event windows 209, 211, 213, and 215 are examples only and are not intended to be limiting as to the events or types of events in environment 100 that are linked in one or more user trails 260.

An advantage provided by the systems and methods disclosed herein is the removal of the process of searching through all emails/notifications associated with a particular user or multiple users in order to produce compliance reports, informational reports, and/or audit responses. EA computing device 108 can perform a single level of data analysis by retrieving only user trails 260 that include information necessary for generating a report. EA computing device 108, because of the generation of user trails 260, can easily pull all user information specific to a particular offering, without having to determine which offering a particular email/notification is associated with.

In some embodiments, because data in user trails 260 is generated and stored independently of the data in database 212, which is used primarily for other system functions (e.g., compiling aggregate offers and allocating assets), a format and/or content of user trail records 262 is not constrained by the parameters of those other system functions. Rather, a format and/or content of user trail records 262 can be tailored specifically for compliance reporting and/or audit responses. Moreover, because user trail records 262 are stored in data maps, EA computing device 108 can efficiently generate complex reports for qualified parties in environment 100. Where any aspect of a public offering becomes the subject of a compliance report, audit response, or informational report, a conventional system would have to rely on proper storage, proper retrieval, manual review, and proper parsing of the contents of a sequence of communications to each individual investor 102 such as notification communications 206, 214, 220, 228, 242, etc. (including potentially separating communications related to the subject offering from communications related to separate offers of public assets) in order to generate the report. A correspondingly large amount of computational resources is required to complete this task, and there are numerous opportunities in such a process for inaccuracies to be introduced into the resulting report. In contrast, using the systems and methods of the present disclosure, the automatic generation and storage of a separate user trail 260 specific to each party for a given offering object 250 provides a dedicated, linked set of data elements that automatically provides precisely the information and sequencing required for the compliance report, audit response, or informational report. This represents a significant improvement in that complex reports can be efficiently and accurately generated by EA computing device 108 from the detailed and thorough data maps of activity in environment 100, including actions taken by EA computing device 108 and activity transmitted from other computing devices in environment 100 (e.g., investor computing devices 102, broker-dealer computing devices 104, etc.).

In some embodiments, different data maps in database 270 may include copies of the same event, but may be specifically tailored to a specific party in database 270. For example, consider activity occurring as shown in FIG. 2A. As explained above, in the example embodiment, offer data 204 and modification data 210 are stored in database 212. In some embodiments, offer data 204 and modification data 210 are also stored in a plurality of user trails 260 in database 270. For example, offer data 204 and modification data 210 may be stored in each of a user trail 260 associated with a particular individual investor 102, a broker-dealer associated with broker-dealer computing device 104, and a data map associated with the offering the participant made an offer to participate in (e.g., via COB 202). Accordingly, the participant at investor computing device 102 may have access to the data map associated with the participant, the broker-dealer at broker-dealer computing device 104 may have access to the data map associated with the broker-dealer, and so forth. In some embodiments, access to data in database 212 is controlled by EA computing device 108 (e.g., by requiring a username and password).

For example, broker-dealer computing device 104 may request an informational report of activity within the past month relating to broker-dealer 104 for all public offerings being handled by EA computing device 108 (e.g., via a request signal). Upon receipt of such a request, EA computing device 108 may be configured to retrieve user trails 260 from database 270 for all individual investors 102 linked to broker-dealer 104, and generate the requested reporting details for the requesting broker-dealer 104. Alternatively, EA computing device 108 may be configured to compile a user trail 260 specific to broker-dealer 104 as events occur for any individual investor 102 associated with broker-dealer 104, and EA computing device 108 may generate the requested reporting details for the requesting broker-dealer 104 directly from that single dedicated user trail 260.

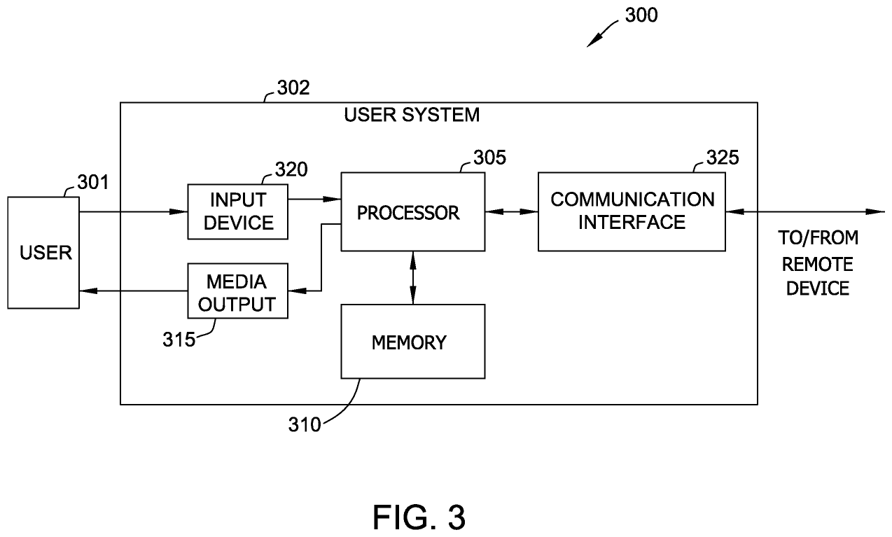

FIG. 3 is an example configuration of a client system 302 that may be used to implement broker-dealer computing devices 104, investor computing devices 102, institutional investor computing devices 110, and/or issuer computing device 106 in accordance with embodiments of the present disclosure. In the example embodiment, client system 302 is operable by a user 301, such as a participant/investor, a broker-dealer, or an issuer. Client system 302 includes a processor 305 for executing instructions stored in a memory area 310. Processor 305 may, for example, include one or more processing units (e.g., in a multi-core configuration). Memory area 310 may, for example, be any device allowing information such as executable instructions and/or investor data to be stored and retrieved. Memory area 310 may further include one or more computer readable media.

In the example embodiment, client system 302 further includes at least one media output component 315 for presenting information to user 301. Media output component 315 may, for example, be any component capable of converting and conveying electronic information to user 301. For example, media output component 315 may be a display component configured to display component lifecycle data in the form of reports, dashboards, communications, and the like In some embodiments, media output component 315 includes an output adapter (not shown), such as a video adapter and/or an audio adapter, which is operatively coupled to processor 305 and operatively connectable to an output device (also not shown), such as a display device (e.g., a cathode ray tube (CRT), liquid crystal display (LCD), light emitting diode (LED) display, or “electronic ink” display) or an audio output device (e.g., a speaker or headphones).

In some embodiments, media output component 315 is configured to include and present a graphical user interface (not shown), such as a web browser and/or at least one client application, to user 301. The graphical user interface may include, for example, an interface for viewing and/or responding to offers or other information transmitted from EA computing device 108. In some embodiments, client system 302 includes an input device 320 for receiving input from user 301. User 301 may use input device 320 to, without limitation, select offers and/or enter a share and/or purchase request, access log-in credential information, respond to modification messages 220, 242 and/or submit payment information. Input device 320 may include, for example, a keyboard, a pointing device, a mouse, a stylus, a touch sensitive panel, a touch pad, a touch screen, a gyroscope, an accelerometer, a position detector, an audio input device, a fingerprint reader/scanner, a palm print reader/scanner, a iris reader/scanner, a retina reader/scanner, a profile scanner, or the like. A single component such as a touch screen may function as both an output device of media output component 315 and input device 320. Client system 302 may also include a communication interface 325, which is communicatively connectable to a remote device such as EA computing device 108 (shown in FIG. 1). Communication interface 325 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

Stored in memory area 310 are, for example, computer readable instructions for providing a user interface to user 301 via media output component 315 and, optionally, receiving and processing input from input device 320. A user interface may include, among other possibilities, a web browser, and at least one client application. Web browsers enable users, such as user 301, to display and interact with media and other information typically embedded on a web page or a website from EA computing device 108. A client application allows user 301 to interact with a server application from EA computing device 108. For example, instructions may be stored by a cloud service, and the output of the execution of the instructions sent to the media output component 315.

Processor 305 executes computer-executable instructions for implementing aspects of the disclosure. In some embodiments, the processor 305 is transformed into a special purpose microprocessor by executing computer-executable instructions or by otherwise being programmed.

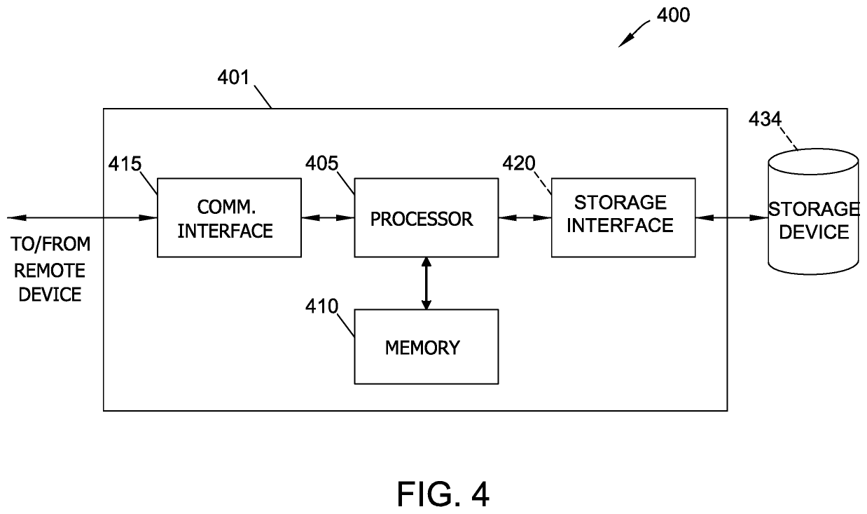

FIG. 4 illustrates an example configuration of a server system 400 that may be used to implement EA computing device 108 (shown in FIG. 1). In the example embodiment, server system 400 includes at least one server computing device 401, in electronic communication with at least one storage device 425. In the exemplary embodiment, server computing device 401 includes a processor 405 for executing instructions (not shown) stored in a memory area 410. In an embodiment, processor 405 may include one or more processing units (e.g., in a multi-core configuration) for executing instructions. The instructions may be executed within various different operating systems on the server system 400, such as UNIX®, LINUX® (LINUX is a registered trademark of Linus Torvalds), Microsoft Windows®, etc. More specifically, the instructions may cause various data manipulations on data stored in storage device 425 (e.g., create, read, update, and delete procedures). It should also be appreciated that upon initiation of a computer-based method, various instructions may be executed during initialization. Some operations may be required in order to perform one or more processes described herein, while other operations may be more general and/or specific to a particular programming language (e.g., C, C #, C++, JSDA, or other suitable programming languages, etc.).

In the example embodiment, processor 405 is operatively coupled to a communication interface 415 such that server system 400 is capable of communicating with a remote device such as investor computing device 102, issuer computing device 106, another EA computing device 108, and/or broker-dealer computing device 104. For example, communication interface 415 may receive requests from remote devices via the Internet.

In the example embodiment, processor 405 is also operatively coupled to a storage device 425, which may be, for example, any computer-operated hardware unit suitable for storing and/or retrieving data. Storage device 425 is used, for example, to store database 212 and/or database 270 including a plurality of data maps as described herein. In some embodiments, storage device 425 is integrated in server system 400. For example, server system 400 may include one or more hard disk drives as storage device 425. In other embodiments, storage device 425 is external to server system 400 and may be accessed by a plurality of server systems 400. For example, storage device 425 may include multiple storage units such as hard disks or solid state disks in a redundant array of inexpensive disks (RAID) configuration. Storage device 425 may include a storage area network (SAN) and/or a network attached storage (NAS) system.

In some embodiments, processor 405 is operatively coupled to storage device 425 via a storage interface 420. Storage interface 420 may include, for example, a component capable of providing processor 405 with access to storage device 425. In an exemplary embodiment, storage interface 420 further includes one or more of an Advanced Technology Attachment (ATA) adapter, a Serial ATA (SATA) adapter, a Small Computer System Interface (SCSI) adapter, a RAID controller, a SAN adapter, a network adapter, and/or any similarly capable component providing processor 405 with access to storage device 425.

Memory area 410 may include, but is not limited to, random-access memory (RAM) such as dynamic RAM (DRAM) or static RAM (SRAM), read-only memory (ROM), erasable programmable read-only memory (EPROM), electrically erasable programmable read-only memory (EEPROM), non-volatile RAM (NVRAM), and magneto-resistive random-access memory (MRAM). The above memory types are for example only, and are thus not limiting as to the types of memory usable for storage of a computer program.

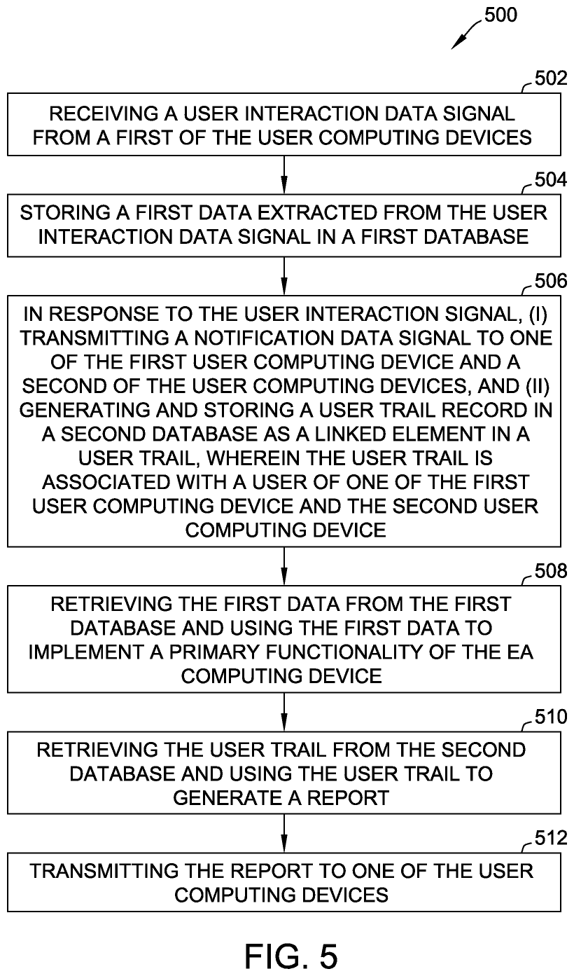

FIG. 5 is a flow diagram illustrating an example method 500 by which activity may be tracked and analyzed using EA computing device 108 as shown in FIG. 1.

In the example embodiment, method 500 includes receiving 502 a user interaction data signal (e.g., COB 202) from a first of the user computing devices (e.g., investor computing device 102) and storing 504 a first data (e.g., offer data 204) extracted from the user interaction data signal in a first database (e.g., database 212). Method 500 also includes, in response to the user interaction signal, (i) transmitting 506 a notification data signal to one of the first user computing device and a second of the user computing devices, and (ii) generating and storing a user trail record in a second database as a linked element in a user trail, wherein the user trail is associated with a user of one of the first user computing device and the second user computing device. Method 500 further includes retrieving 508 the first data from the first database and using the first data to implement a primary functionality of the EA computing device, retrieving 510 the user trail from the second database and using the user trail to generate a report, and transmitting 512 the report to one of the user computing devices.

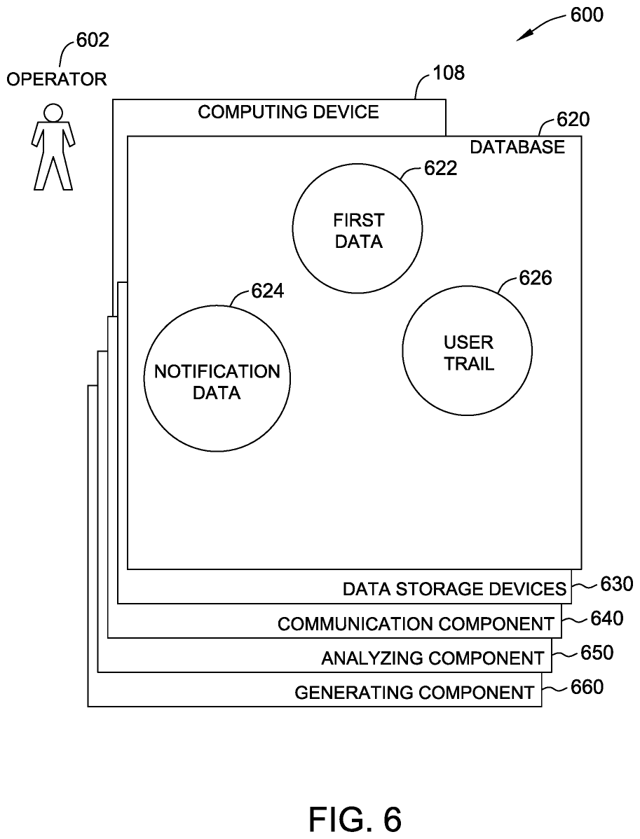

FIG. 6 is a diagram 600 of example computer components that may be executed by EA computing device 108. The computer components may be used to, for example, complete method 500 as described above with respect to FIG. 5. An operator 602 may access EA computing device 108 in order to initiate various operations and/or service EA computing device 108. In some embodiments, database 620 is similar to database 212, as shown in FIG. 2. Database 620 may be implemented on one or more data storage devices 630 and coupled with several components within computing device 610, which perform specific tasks. For example, in some embodiments database 620 may include more than one database. In the example embodiment, database 620 includes first data 622 (e.g., offer data 204), notification data 624, and user trail 626.

In the example embodiment, EA computing device 108 includes a communication component 640 programmed to, as examples, receive 502 a user interaction data signal, transmit 506 a notification data signal to a user computing device, and transmit 512 the report to one of the user computing devices (as shown in FIG. 5).

In the example embodiment, EA computing device 108 further includes an analyzing component 650 programmed to, as an example, retrieve 508 the first data from the first database and using the first data to implement a primary functionality of the EA computing device (as shown in FIG. 5). EA computing device 108 also includes a generating component 660 programmed to, as examples, retrieve 510 the user trail from the second database and using the user trail to generate a report and generate and store a user trail record in a second database as a linked element in a user trail, wherein the user trail is associated with a user of one of the first user computing device and the second user computing device.

While the disclosure has been described in terms of various specific embodiments, those skilled in the art will recognize that the disclosure can be practiced with modification within the spirit and scope of the claims.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

As will be appreciated based on the foregoing specification, the above-described embodiments of the disclosure may be implemented using computer programming or engineering techniques including computer software, firmware, hardware or any combination or subset thereof, wherein the technical effect is a flexible system for analyzing and tracking financial events. Any such resulting program, having computer-readable code means, may be embodied or provided within one or more computer-readable media, thereby making a computer program product, i.e., an article of manufacture, according to the discussed embodiments of the disclosure. The article of manufacture containing the computer code may be made and/or used by executing the code directly from one medium, by copying the code from one medium to another medium, or by transmitting the code over a network.

In addition, although various elements of the SDA computing device are described herein as including general processing and memory devices, it should be understood that the EA computing device is a specialized computer configured to perform the steps described herein for tracking and analyzing activity, specifically activity regarding a public offering as described herein.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial locational differences from the literal language of the claims.

What is claimed is:

1. An event analysis (EA) computing device comprising at least one processor in communication with a database and a plurality of user computing devices corresponding to a plurality of users, the at least one processor configured to:
receive a user interaction data signal from a first of the user computing devices;
store a first data extracted from the user interaction data signal in a first database;
in response to the user interaction data signal, (i) transmit a notification data signal to one of the first user computing device and a second of the user computing devices, and (ii) generate and store a user trail record in a second database as a linked element in a user trail, wherein the user trail is associated with a user of one of the first user computing device and the second user computing device;
retrieve the first data from the first database and use the first data to implement a primary functionality of the EA computing device;
retrieve the user trail from the second database and use the user trail to generate a report; and
transmit the report to one of the user computing devices.

2. The EA computing device according to claim 1, wherein the user trail is one of a plurality of user trails stored in the second database, and wherein the at least one processor is further configured to retrieve the user trail from the second database by querying the second database for one of the user trails corresponding to a specified one of the users.

3. The EA computing device according to claim 1, wherein:
the plurality of users includes a plurality of individual investors;
the at least one processor is further configured to implement the primary functionality by compiling an aggregate offer from the plurality of individual investors to an issuer of a public offering of assets, and allocating any resulting assets made available by the issuer among the plurality of individual investors; and
a plurality of user trails includes a respective user trail for each of the plurality of individual investors.

4. The EA computing device according to claim 3, wherein the user interaction data signal comprises a conditional offer to buy from one of the plurality of individual investors, and wherein the at least one processor is further configured to create an order data object in response to the user interaction data signal, the order data object being specific to the public offering of assets and the one of the individual investors.

5. The EA computing device according to claim 4, wherein the at least one processor is further configured to:
receive a registration signal for the public offering of assets from an issuer computing device associated with the issuer; and
in response to the registration signal, create an offering data object, wherein the order data object inherits the attributes of the offering data object.

6. The EA computing device according to claim 1, wherein the at least one processor is further configured to:
receive, from the one of the user computing devices, a request signal requesting one of a compliance report, an audit response report, and an informational report; and
retrieve the user trail from the second database in response to the request signal.

7. The EA computing device according to claim 6, wherein the one of the user computing devices is a broker-dealer computing device associated with one of the users being a broker-dealer, and wherein the at least one processor is further configured to:
retrieve the user trail as one of a plurality of user trails, each user trail of the plurality of user trails associated with a respective one of the users being an individual investor linked to the broker-dealer; and
generate the report using the plurality of user trails.

8. The EA computing device according to claim 6, wherein the one of the user computing devices is a broker-dealer computing device associated with one of the users being a broker-dealer, and wherein the at least one processor is further configured to retrieve the user trail as a single user trail associated with the broker-dealer.

9. A computer-implemented method, said method implemented by an event analysis (EA) computing device comprising at least one processor in communication with a database and a plurality of user computing devices corresponding to a plurality of users, said method comprising:
receiving a user interaction data signal from a first of the plurality of user computing devices;
storing a first data extracted from the user interaction data signal in a first database;
in response to the user interaction data signal, (i) transmitting a notification data signal to one of the first user computing device and a second of the user computing devices, and (ii) generating and storing a user trail record in a second database as a linked element in a user trail, wherein the user trail is associated with a user of one of the first user computing device and the second user computing device;
retrieving the first data from the first database and using the first data to implement a primary functionality of the EA computing device;
retrieving the user trail from the second database and using the user trail to generate a report; and
transmitting the report to one of the user computing devices.

10. The method of claim 9, wherein the user trail is one of a plurality of user trails stored in the second database, the method further comprising retrieving the user trail from the second database by querying the second database for one of the user trails corresponding to a specified one of the users.

11. The method of claim 9, wherein the plurality of users includes a plurality of individual investors, the method further comprising:
implementing the primary functionality by compiling an aggregate offer from the plurality of individual investors to an issuer of a public offering of assets; and
allocating any resulting assets made available by the issuer among the plurality of individual investors, wherein a plurality of user trails includes a respective user trail for each of the plurality of individual investors.

12. The method of claim 11, wherein the user interaction data signal comprises a conditional offer to buy from one of the plurality of individual investors, the method further comprising creating an order data object in response to the user interaction data signal, the order data object being specific to the public offering of assets and the one of the individual investors.

13. The method of claim 12, further comprising:
receiving a registration signal for the public offering of assets from an issuer computing device associated with the issuer; and
in response to the registration signal, creating an offering data object, wherein the order data object inherits the attributes of the offering data object.

14. The method of claim 9, further comprising:
receiving, from the one of the user computing devices, a request signal requesting one of a compliance report, an audit response report, and an informational report; and
retrieving the user trail from the second database in response to the request signal.

15. A non-transitory computer-readable storage medium having computer-executable instructions embodied thereon, wherein when executed by at least one event analysis (EA) computing device, including at least one processor in communication with at least one database and a plurality of user computing devices corresponding to a plurality of users, the computer-executable instructions cause the EA computing device to:
receive a user interaction data signal from a first of the plurality of user computing devices;
store a first data extracted from the user interaction data signal in a first database;
in response to the user interaction data signal, (i) transmit a notification data signal to one of the first user computing device and a second of the user computing devices, and (ii) generate and store a user trail record in a second database as a linked element in a user trail, wherein the user trail is associated with a user of one of the first user computing device and the second user computing device;
retrieve the first data from the first database and use the first data to implement a primary functionality of the EA computing device;
retrieve the user trail from the second database and use the user trail to generate a report; and
transmit the report to one of the user computing devices.

16. The non-transitory computer-readable storage medium of claim 15, wherein the user trail is one of a plurality of user trails stored in the second database, and wherein the instructions further cause the EA computing device to retrieve the user trail from the second database by querying the second database for one of the user trails corresponding to a specified one of the users.

17. The non-transitory computer-readable storage medium of claim 15, wherein the plurality of users includes a plurality of individual investors, and wherein the instructions further cause the EA computing device to implement the primary functionality by compiling an aggregate offer from the plurality of individual investors to an issuer of a public offering of assets, and allocating any resulting assets made available by the issuer among the plurality of individual investors, wherein a plurality of user trails includes a respective user trail for each of the plurality of individual investors.

18. The non-transitory computer-readable storage medium of claim 17, wherein the user interaction data signal comprises a conditional offer to buy from one of the plurality of individual investors, and wherein the instructions further cause the EA computing device to create an order data object in response to the user interaction data signal, the order data object being specific to the public offering of assets and the one of the individual investors.

19. The non-transitory computer-readable storage medium of claim 18, wherein the instructions further cause the EA computing device to:
receive a registration signal for the public offering of assets from an issuer computing device associated with the issuer; and
in response to the registration signal, create an offering data object, wherein the order data object inherits the attributes of the offering data object.

20. The non-transitory computer-readable storage medium of claim 15, wherein the instructions further cause the EA computing device to:
receive, from the one of the user computing devices, a request signal requesting one of a compliance report, an audit response report, and an informational report; and
retrieve the user trail from the second database in response to the request signal.
